(19) United States
(12) Patent Application Publication
(10) Pub. No.: US 2026/0141832 A1
(43) Pub. Date: May 21, 2026

(54) CONTROL METHOD FOR REDUCING OPERATING TEMPERATURE AND DRIVING DEVICE

(71) Applicant: NOVATEK Microelectronics Corp., Hsin-Chu (TW)

(72) Inventors: Han-Kun Wu, Hsinchu City (TW); Jen-Chieh Hu, Hsinchu County (TW); Ching-Wen Hou, Hsinchu City (TW); Yu-Hsiang Hsu, Kaohsiung City (TW)

(73) Assignee: NOVATEK Microelectronics Corp., Hsin-Chu (TW)

(21) Appl. No.: 18/951,713

(22) Filed: Nov. 19, 2024

(51) Int. Cl. G09G 3/00; G09G 3/20; G09G 3/36

(52) U.S. Cl. CPC G09G 3/006; G09G 3/2007; G09G 3/3614; G09G 2330/023; G09G 2330/045

(57) ABSTRACT

A control method for reducing operating temperature of a driving device is provided. The driving device includes a plurality of channel driving circuits. The control method includes enabling an over-temperature sensing function to determine whether to perform a temperature reducing operation, and for each line period, determining that the plurality of channel driving circuits perform an overdriving operation or a charge sharing operation during the line period by comparing a gray level of channel data of a channel in the line period with a gray level of channel data of the channel in a previous line period before the line period in response to determining to perform the temperature reducing operation.

### BACKGROUND OF THE INVENTION

### 1. Field of the Invention

The present invention relates to a control method and a driving device, and more particularly, to a control method and a driving device capable of reducing device temperature.

### 2. Description of the Prior Art

With development of display technology, flat panel displays, such as liquid crystal display (LCD), or organic light emitting diode (OLED) display, are widely applied in various electronic products, e.g., notebooks, televisions, mobile handsets. The display device now has higher resolutions and higher frame rate. Moreover, the size of a display panel in the display device is getting larger to meet demands, which results in an increase in the number of pixels in the display panel. The large display device would consume more power for operation, and thus causing the temperature of internal device increases promptly. Furthermore, the display device usually uses driving circuits to drive pixels on the display panel for displaying image data. Since a polarity inversion mechanism is applied, the driving circuit may constantly provide the driving voltages with positive polarity and negative polarity which are alternately switched to the display panel during operation. As such, the interior temperature of the driving circuits may be dramatically increased. Excessive heat of the driving circuits may lead to abnormal display situation, reduced efficiency, lower reliability, damage to components and even device failure. Traditional method may apply heat dissipation modules, such heat dissipation adhesive, heat dissipation patch (or dissipation tape) on the packaging of the driving device to dissipate the heat generated by the circuit components. However, the additional dissipation module may increase the production cost. Thus, there is a need for improvement over the prior art.

### SUMMARY OF THE INVENTION

It is therefore an objective of the present invention to provide a control method and a driving device capable of reducing device temperature, to solve the abovementioned problem.

According to an embodiment of the present invention, a control method for reducing operating temperature of a driving device is provided. The driving device comprises a plurality of channel driving circuits, the control method includes: enabling an over-temperature sensing function to determine whether to perform a temperature reducing operation; and for each line period, determining that the plurality of channel driving circuits perform an overdriving operation or a charge sharing operation during the line period by comparing a gray level of channel data of a channel in the line period with a gray level of channel data of the channel in a previous line period before the line period in response to determining to perform the temperature reducing operation.

According to an embodiment of the present invention, a driving device is provided. The driving device includes: a plurality of channel driving circuits; and a processing circuit, configured to enable an over-temperature sensing function and determine whether to perform a temperature reducing operation; and wherein for each line period, the processing circuit is further configured to determine that the plurality of channel driving circuits perform an overdriving operation or a charge sharing operation during the line period by comparing a gray level of channel data of a channel in the line period with a gray level of channel data of the channel in a previous line period before the line period in response to determining to perform the temperature reducing operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to an embodiment of the present invention.

FIG. 2 is a flow diagram of a procedure according to an embodiment of the present invention.

FIG. 3 is a schematic diagram illustrating a heavy loading pattern of 1H-stripe according to an embodiment of the present invention.

FIG. 4 is a schematic diagram illustrating a heavy loading pattern frame pattern of two-stripes according to an embodiment of the present invention.

FIG. 5 is a schematic diagram illustrating the comparison operation of gray level of channel data according to an embodiment of the present invention.

FIG. 6 is a waveform diagram of the display device according to an embodiment of the invention.

FIG. 7 is a schematic diagram illustrating a channel driving circuit according to an embodiment of the invention.

FIG. 8 is a schematic diagram illustrating operations of the channel driving circuit with the positive polarity shown in FIG. 7 during the activation period of the line period according to an embodiment of the invention.

FIG. 9 is a schematic diagram illustrating operations of outputting the data driving voltage corresponding to the channel data of the channel driving circuit with the positive polarity shown in FIG. 7 according to an embodiment of the invention.

FIG. 10 is a schematic diagram illustrating operations of the channel driving circuit with the negative polarity shown in FIG. 7 during the activation period of the line period according to an embodiment of the invention.

FIG. 11 is a schematic diagram illustrating operations of outputting the data driving voltage corresponding to the channel data of the channel driving circuit with the negative polarity shown in FIG. 7 according to an embodiment of the invention.

FIG. 12 is a schematic diagram illustrating a channel driving circuit according to an alternative embodiment of the invention.

FIG. 13 is a schematic diagram illustrating operations of the channel driving circuits shown in FIG. 12 during the activation period of the line period according to an embodiment of the invention.

FIG. 14 is a schematic diagram illustrating operations of outputting the data driving voltage corresponding to the channel data of the channel driving circuits shown in FIG. 12 according to an embodiment of the invention.

FIG. 15 is a schematic diagram illustrating a channel driving circuit according to an alternative embodiment of the invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

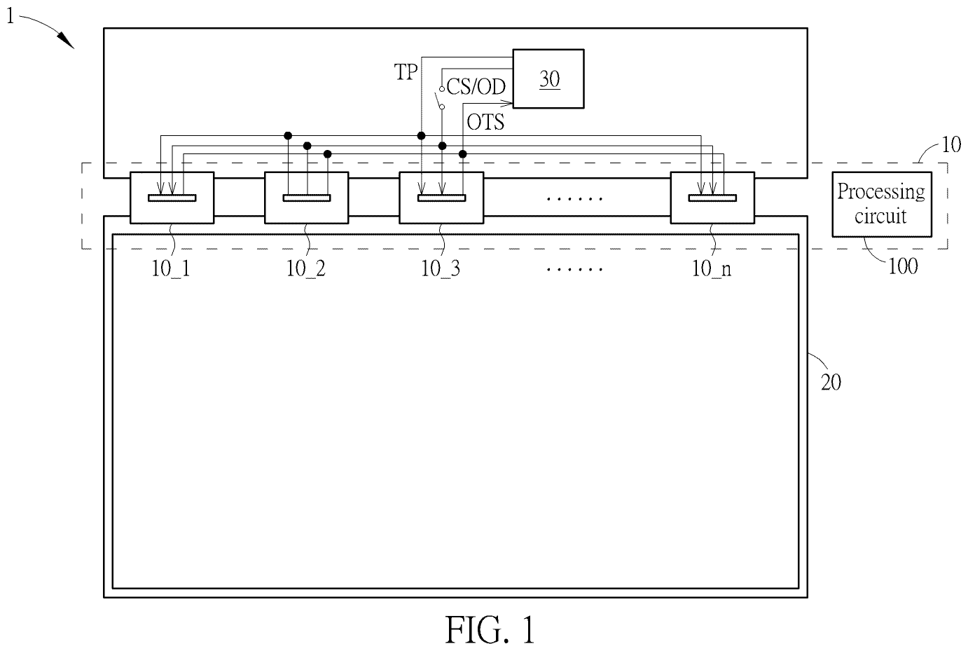

Please refer to FIG. 1, which is a schematic diagram of a display device 1 according to an embodiment of the present invention. The display device 1 may be utilized in an electronic product with a display panel, such as smart phone, laptop, tablet, television or monitor. For example, the display device 1 in FIG. 1 shows an exemplary embodiment of a liquid crystal display (LCD) device. Besides, the display device 1 could be an organic light emitting diode (OLED) display or a micro light emitting diode (micro LED) display, but not limited thereto. The display device 1 includes a driving device 10, a display panel 20 and a timing controller 30. As shown in FIG. 1, the driving device 10 is coupled to the display panel 20 and the timing controller 30. The driving device 10 includes channel driving circuits 10_1 to 10_n and a processing circuit 100. In an embodiment, the driving device 10 may be implemented in an integrated circuit (IC) as a display driver IC (DDIC). The processing circuit 100 may be configured to determine whether to perform an overdriving operation or a charge sharing operation for each line period in order to implement the temperature reducing operation for the driving device 10. The processing circuit 100 may be a main controller or processing device, such as a central processing unit (CPU), microprocessor, or micro controller unit (MCU). Each channel driving circuit may correspond to at least one channel and generate at least one deriving voltage according to channel data of the corresponding channel to drive the display panel 20 during a line period.

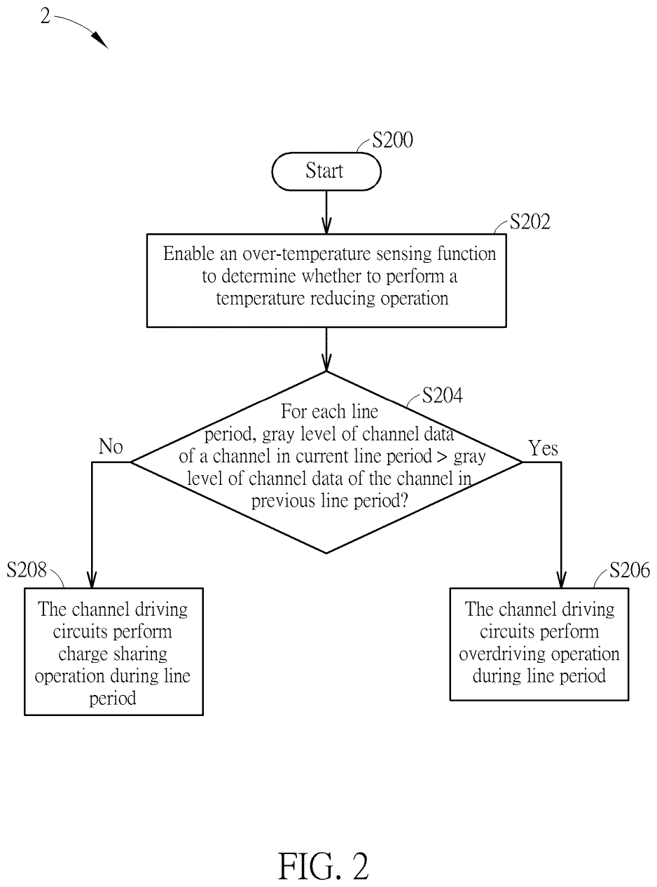

Please refer to FIG. 2 which is a flow diagram of a procedure 2 according to an embodiment of the present invention. The procedure 2 can be applied to the display device 1 shown in FIG. 1. The procedure 2 at least includes the following steps:
Step S200: Start.
Step S202: Enable an over-temperature sensing function to determine whether to perform a temperature reducing operation.
Step S204: For each line period, determine that the channel driving circuits perform an overdriving operation or a charge sharing operation during the line period by comparing a gray level of channel data of a channel in the line period with a gray level of channel data of the channel in a previous line period before the line period in response to determining to perform the temperature reducing operation, and determine whether the gray level of the channel data of the channel in the current line period is larger than the gray level of the channel data of the channel in the previous line period. If yes, go to Step 206; otherwise, go to Step 208.
Step S206: The channel driving circuits perform the overdriving operation during the line period.
Step S208: The channel driving circuits perform the charge sharing operation during the line period.

According to the procedure 2, in Step S202, the processing circuit 100 is configured to enable an over-temperature sensing function to determine whether to perform a temperature reducing operation for the driving device 10. In an alternative embodiment, the timing controller 30 may transmit a command signal indicating activation of the over-temperature sensing function to the driving device 10. After receiving the command signal, the processing circuit 100 enables the over-temperature sensing function in response to receiving the command signal from the timing controller 30. The driving device 10 may be equipped with at least one temperature sensor for detecting the temperature of the driving device 10 (e.g., temperature of channel driving circuits 10_1 to 10_n. The temperature sensor may be a thermistor or a resistance temperature detector, and this should not be a limitation of the invention. When the over-temperature sensing function is enabled, the processing circuit 100 may obtain information of the temperature of the driving device 10 from the temperature sensor and compare the temperature of the driving device 10 with a temperature threshold value. When determining that the temperature of the driving device 10 is higher than the temperature threshold value, the processing circuit 100 determines to perform a temperature reducing operation for the driving device 10. In addition, the timing controller 30 may transmit a command signal indicating that the temperature of the driving device 10 is higher than the temperature threshold value to the driving device 10. After receiving the command signal indicating that the temperature of the driving device 10 is higher than the temperature threshold value, the processing circuit 100 determines to perform a temperature reducing operation for the driving device 10.

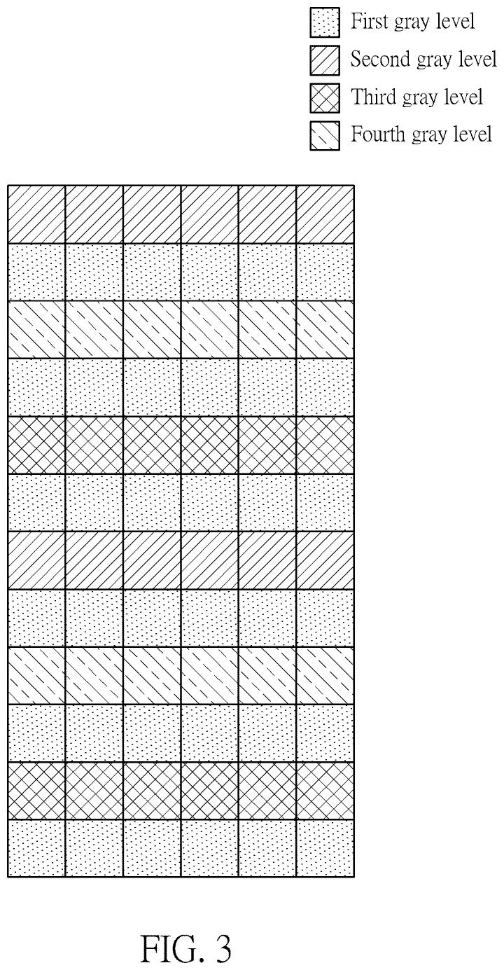

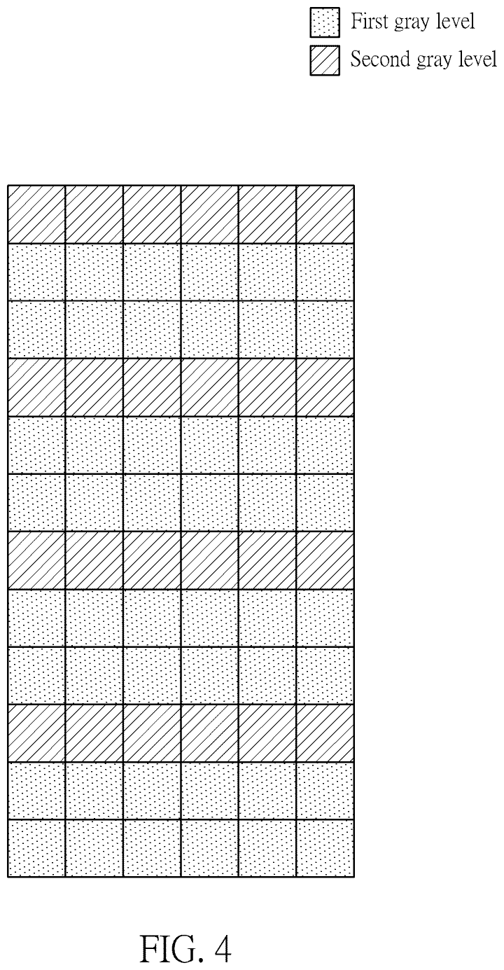

In an alternative embodiment, when the over-temperature sensing function is enabled, the processing circuit 100 may analysis display frame data to be displayed in the subsequent display period. The processing circuit 100 may determine whether the display frame data to be displayed in the subsequent display period includes a heavy load pattern. The processing circuit 100 may utilize a pattern detection function (PDF) to detect whether the display frame data to be displayed in the subsequent display period includes a heavy load pattern. For example, please refer to FIG. 3 and FIG. 4. FIG. 3 is a schematic diagram illustrating a heavy loading pattern of 1H-stripe according to an embodiment of the present invention. FIG. 4 is a schematic diagram illustrating a heavy loading pattern of (1+2H) stripe according to an embodiment of the present invention. FIG. 3 and FIG. 4 represent display frame data. Each square grid represents channel data. The background stripe and pattern of each square grid represents the gray level value of channel data. Each channel data column may correspond to a channel of the display panel 30, and each channel data row may correspond to a line period (e.g., scan line period corresponding to a scan line). Different background stripe and pattern represents different gray level value of channel data. As shown in FIG. 3, the gray levels from small to large are: first gray level (e.g., L0), second gray level (e.g., L63), third gray level (e.g., L95), and fourth gray level (e.g., L127). As shown in FIG. 4, the first gray level (e.g., L0) is smaller than the second gray level (e.g., L63). For the display frame data having the heavy loading pattern shown in FIG. 3 and FIG. 4, the channel data in the same line period may have the same or similar gray level value. Moreover, in response to determining that the image frame data includes the heavy load pattern to be displayed, the processing circuit 100 determines to perform a temperature reducing operation for the driving device 10 in the subsequent display period of displaying the display frame data including heavy load pattern.

In an alternative embodiment, the timing controller 30 may detect whether display frame data to be displayed in the subsequent display period includes a heavy load pattern. When determining that the display frame data to be displayed in the subsequent display period includes a heavy load pattern, the timing controller 30 may transmit a command signal indicating that the display frame data to be displayed in the subsequent display period includes a heavy load pattern. After receiving the command signal that the display frame data to be displayed in the subsequent display period includes the heavy load pattern, the processing circuit 100 determines to perform the temperature reducing operation for the driving device 10 in the subsequent display period of displaying the display frame data including heavy load pattern.

In an embodiment, as shown in FIG. 1, the display device 1 may include an enabling switch CS/OD. The enabling switch CS/OD may be disposed between the channel driving circuits 10_1 to 10_n of the driving device 10 and the timing controller 30. When the enabling switch CS/OD is turned on, a temperature reducing operation function is enabled, and the driving device 10 is allowed to perform a temperature reducing operation. When the enabling switch CS/OD is turned off, the temperature reducing operation function is disabled, and the driving device 10 may perform a normal display operation in a normal display state. For example, when determining to perform the temperature reducing operation for the driving device 10, the driving device 10 may transmit a command signal OTS, indicating that the temperature reducing operation is required to be performed, to the timing controller 30. After the timing controller 30 receives the command signal OTS, the enabling switch CS/OD may be turned on by the timing controller 30, such that the temperature reducing operation function is enabled and the driving device 10 is able to perform the temperature reducing operation. Besides, the timing controller 30 may also send an enable signal that allowing the temperature reducing operation to the driving device 10. For example, when determining that the temperature reducing operation is required to be performed, the timing controller 30 may control the enabling switch CS/OD to be turned on, such that the driving device 10 is allowed to perform a temperature reducing operation.

In Step S204, in response to determining to perform the temperature reducing operation, the processing circuit 100 of the driving device 10 is configured to determine whether to perform an overdriving operation or a charge sharing operation for each line period. In more detail, for each line period, the processing circuit 100 is configured to determine that channel driving circuits 10_1-10_n perform an overdriving operation or a charge sharing operation during the line period by comparing a gray level of channel data of at least one channel in the current line period with a gray level of channel data of the at least one channel in a previous line period before the line period in response to determining to perform the temperature reducing operation.

For example, for each line period, the processing circuit 100 may select any channel data in the line period as the basis for comparison. As the channel data corresponding to a channel in the line period is selected, channel data corresponding to the same channel in the previous line period before the line period may be utilized to be compared with the selected channel data corresponding to the selected channel in the line period. The processing circuit 100 may compare a gray level of the selected channel data of the selected channel in the current line period with a gray level of channel data of the selected channel in the previous line period. When determining that the gray level of channel data of the selected channel in the line period is greater than the gray level of channel data of the selected channel in the previous line period, the processing circuit 100 may determine that the channel driving circuits 10_1-10_n perform the overdriving operation to a power supply voltage VDDA or a ground voltage GNDA for temperature reducing during an activation period of a trigger signal within the line period, and the Step S206 is executed. For example, the gray level of channel data of the selected channel in the line period may be between 192 and 255 for 8-bits display image data. The gray level of channel data of the selected channel in the previous line period may be between 0 and 63 for 8-bits display image data. When determining that the gray level of channel data of the selected channel in the line period is smaller than the gray level of channel data of the selected channel in the previous line period, the processing circuit 100 may determine that the channel driving circuits 10_1-10_n perform the charge sharing operation or the overdriving operation to a half power supply voltage HVDDA for temperature reducing during an activation period of a trigger signal within the line period, and the Step S208 is executed. The half power supply voltage HVDDA may be between the power supply voltage VDDA and the ground voltage GNDA. Therefore, the embodiments of the invention may determine whether to perform an overdriving operation or a charge sharing operation for the temperature reducing operation based merely on channel data of single channel without considering the whole display frame data.

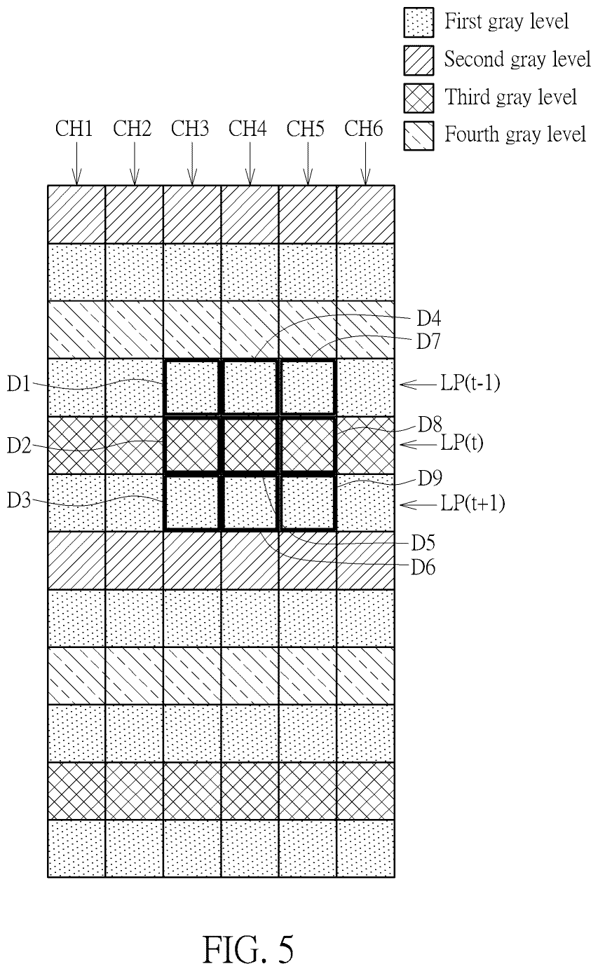

For example, take the display frame data of FIG. 3 as an example, please refer to FIG. 5, which is a schematic diagram illustrating the comparison operation of gray level of channel data according to an embodiment of the present invention. FIG. 5 shows the display frame data of FIG. 3. As shown in FIG. 5, each square grid represents channel data and the background stripe and pattern of each square grid represents the gray level value of the channel data. Each channel data column may correspond to a channel of the display panel 30, and each channel data row may correspond to a line period. Regarding the line period LP(t), the processing circuit 100 may select any channel data of the channel data row corresponding to the line period LP(t) as the basis for comparison. For example, for the line period LP(t), the processing circuit 100 selects channel data D2 of the channel CH3 in the line period LP(t) as the basis for comparison. The processing circuit 100 compares a gray level of the selected channel data D2 of the channel CH3 in the line period LP(t) with a gray level of channel data DI of the channel CH3 in the line period LP(t−1), and determines that the gray level of channel data D2 of the channel CH3 in the line period LP(t) is greater than the gray level of channel data D1 of the channel CH3 in the line period LP(t−1). The processing circuit 100 may determine that the channel driving circuits 10_1-10_n perform the overdriving operation to the power supply voltage VDDA or the ground voltage GNDA during an activation period of a trigger signal within the line period LP(t).

Please further refer to FIG. 5. Regarding the line period LP(t+1), the processing circuit 100 compares a gray level of the channel data D3 of the channel CH3 in the line period LP(t+1) with a gray level of channel data D2 of the channel CH3 in the line period LP(t), and determines that the gray level of channel data D3 of the channel CH3 in the line period LP(t+1) is smaller than the gray level of channel data D2 of the channel CH3 in the line period LP(t). The processing circuit 100 may determine that the channel driving circuits 10_1-10_n perform the charge sharing operation or the overdriving operation to a half power supply voltage HVDDA during an activation period of a trigger signal within the line period LP(t+1).

In an alternative embodiment, for each line period, when determining that the gray level of channel data of the selected channel in the line period is greater than the gray level of channel data of the selected channel in the previous line period and an absolute difference of the gray level of channel data of the channel in the line period and the gray level of channel data of the channel in the previous line period is greater than a first threshold, the processing circuit 100 may determine that the channel driving circuits 10_1-10_n perform the overdriving operation to a power supply voltage VDDA or a ground voltage GNDA during an activation period of a trigger signal within the line period, and the Step S206 is executed. When determining that the gray level of channel data of the selected channel in the line period is smaller than the gray level of channel data of the selected channel in the previous line period and an absolute difference of the gray level of channel data of the channel in the line period and the gray level of channel data of the channel in the previous line period is greater than a second threshold, the processing circuit 100 may determine that the channel driving circuits 10_1-10_n perform the charge sharing operation or the overdriving operation to a half power supply voltage HVDDA during an activation period of a trigger signal within the line period, and the Step S208 is executed. The half power supply voltage HVDDA may be between the power supply voltage VDDA and the ground voltage GNDA.

In an alternative embodiment, for each line period, the processing circuit 100 may determine that channel driving circuits 10_1-10_n perform an overdriving operation or a charge sharing operation during the line period by comparing gray levels of channel data of multiple channels in the current line period with gray levels of channel data of the multiple channels in a previous line period before the line period. Moreover, for each channel, the processing circuit 100 may compare a gray level of channel data of the each channel in the current line period with a gray level of channel data of the each channel in the previous line period. When determining that the gray level of channel data of each channel in the line period is greater than the gray level of channel data of the each channel in the previous line period, the processing circuit 100 may determine that the channel driving circuits 10_1-10_n perform the overdriving operation to the power supply voltage VDDA or the ground voltage GNDA for temperature reducing during an activation period of a trigger signal within the line period, and the Step S206 is executed. For example, as shown in FIG. 5, the processing circuit 100 compares gray levels of channel data of channels CH3 to CH5 in the line period LP(t) with gray levels of channel data of the channels CH3 to CH5 in the line period LP(t−1). For the channel CH3, the gray level of channel data D2 of the channel CH3 in the line period LP(t) is greater than the gray level of channel data D1 of the channel CH3 in the line period LP(t−1). Regarding the channel CH4, the gray level of channel data D5 is greater than the gray level of channel data D4. Regarding the channel CH5, the gray level of channel data D8 is greater than the gray level of channel data D7. Therefore, the processing circuit 100 may determine that the channel driving circuits 10_1-10_n perform the overdriving operation to the power supply voltage VDDA or the ground voltage GNDA during an activation period of a trigger signal within the line period LP(t).

When determining that the gray level of channel data of each channel in the line period is smaller than the gray level of channel data of each channel in the previous line period, the processing circuit 100 may determine that the channel driving circuits 10_1-10_n perform the charge sharing operation or the overdriving operation to a half power supply voltage HVDDA for temperature reducing during an activation period of a trigger signal within the line period, and the Step S208 is executed. For example, as shown in FIG. 5, the processing circuit 100 compares gray levels of channel data of channels CH3 to CH5 in the line period LP(t+1) with gray levels of channel data of the channels CH3 to CH5 in the line period LP(t). For the channel CH3, the gray level of channel data D3 of the channel CH3 in the line period LP(t) is smaller than the gray level of channel data D2 of the channel CH3 in the line period LP(t−1). Regarding the channel CH4, the gray level of channel data D6 is smaller than the gray level of channel data D5. Regarding the channel CH5, the gray level of channel data D9 is smaller than the gray level of channel data D8. Under such a situation, the processing circuit 100 may determine that the channel driving circuits 10_1-10_n perform the charge sharing operation or the overdriving operation to the half power supply voltage HVDDA for temperature reducing during an activation period of a trigger signal within the line period.

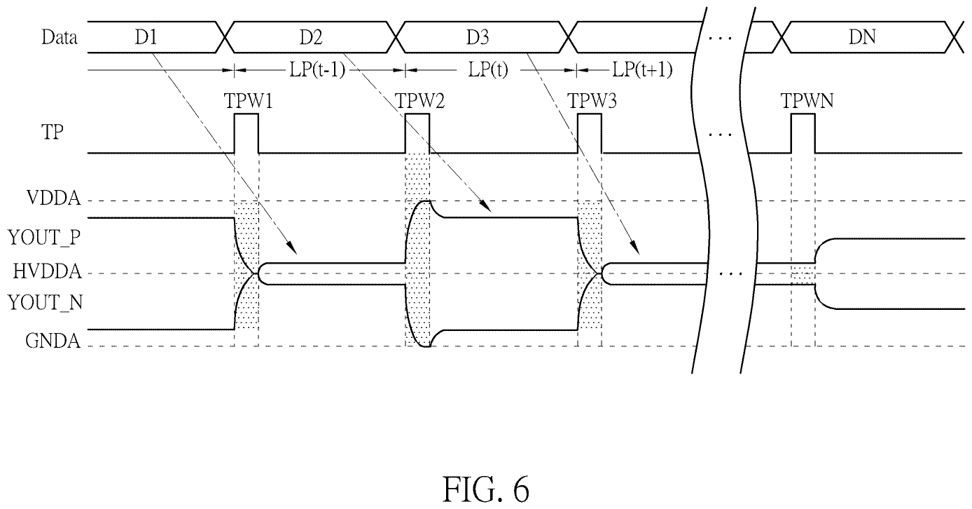

In Step S206, in response to determining that the channel driving circuits performs the overdriving operation a power supply voltage VDDA or a ground voltage GNDA for the line period, the channel driving circuits 10_1-10_n perform an overdriving operation a power supply voltage VDDA or a ground voltage GNDA according to a trigger signal during the line period. For example, please further refer to FIG. 6, the channel driving circuits 10_1-10_n may perform an overdriving operation a power supply voltage VDDA or a ground voltage GNDA during an activation period TPW2 of a trigger signal TP within the line period within the line period LP(t) since the processing circuit 100 determines to perform the overdriving operation for the line period LP(t) in Step S204. The driving device 10 may receive a trigger signal TP from the timing controller 30. The time period between two consecutive rising edges of the trigger signal TP may define a line period (e.g., a display cycle or scan line period). For example, as shown in FIG. 6, a logic high period of the trigger signal TP indicates an activation period of the trigger signal TP. The time length of the activation period of the trigger signal TP for each line period may be adjusted in accordance with practical requirements. The trigger signal TP may also determine the timing of outputting driving voltages corresponding to channel data in each line period. For example, a falling edge of the trigger signal TP within each line period may be a triggering timing of outputting driving voltages corresponding to channel data in each line period (normal display operation).

When a polarity inversion mechanism is applied, some of the channel driving circuits 10_1-10_n may be the channel driving circuits with positive polarity for outputting positive polarity voltages to drive the display panel 20 in the line period LP(t) and the others may be the channel driving circuits with negative polarity for outputting negative polarity voltages to drive the display panel 20 in the line period LP(t). Therefore, each channel driving circuit with the positive polarity may output a first voltage via the output terminal OUT_P during the activation period TPW2 of the trigger signal TP within the line period LP(t) for implementing the overdriving operation, wherein the first voltage may be the power supply voltage VDDA. Each channel driving circuit with the negative polarity may output a second voltage via the output terminal OUT_N during the activation period TPW2 of the trigger signal TP within the line period LP(t) for implementing the overdriving operation, wherein the second voltage may be the ground voltage GNDA.

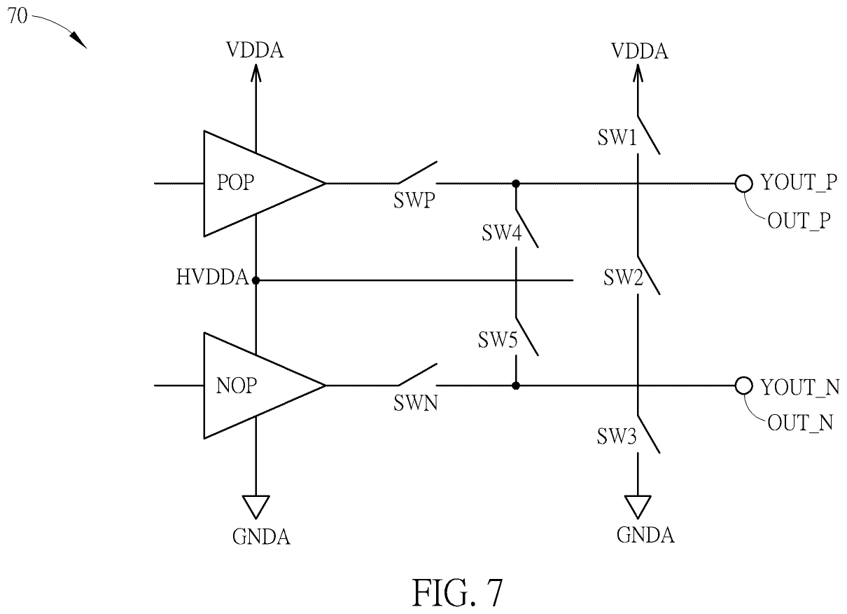

Please refer FIG. 7. FIG. 7 is a schematic diagram illustrating a channel driving circuit 70 according to an embodiment of the invention. Each of the channel driving circuits 10_1-10_n may be implemented by using the channel driving circuit 70 of FIG. 7. As shown in FIG. 7, the channel driving circuit 70 includes operational amplifiers POP and NOP, switches SWP, SWN, SW1-SW5 and output terminals OUT_P and OUT_N. The operational amplifier POP may be operated between a power supply voltage VDDA and a half power supply voltage HVDDA and capable of outputting a data driving voltage of positive polarity. The operational amplifier NOP may be operated between the half power supply voltage HVDDA and a ground voltage GNDA and capable of outputting a data driving voltage of negative polarity. The half power supply voltage HVDDA may be between the power supply voltage VDDA and the ground voltage GNDA. The switch SWP is coupled between the operational amplifier POP and the output terminal OUT_P. The switch SW1 is coupled between a power supply terminal of the power supply voltage VDDA and the output terminal OUT_P. The switch SWN is coupled between the operational amplifier NOP and the output terminal OUT_N. The switch SW3 is coupled between a ground terminal of a ground voltage GNDA and the output terminal OUT_N. The output terminals YOUT_P and YOUT_N may be coupled to the display panel 20.

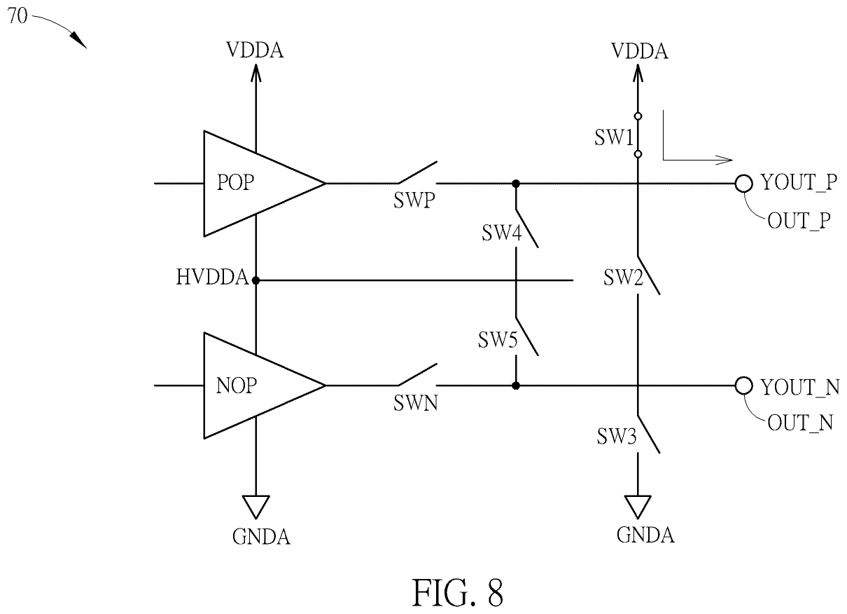

In an embodiment, please refer to FIG. 6 and FIG. 8. FIG. 8 is a schematic diagram illustrating operations of the channel driving circuit 70 with the positive polarity during the activation period TPW2 of the line period LP(t) according to an embodiment of the invention. If the channel driving circuit 70 is the channel driving circuit with the positive polarity, the switch SW1 is turned on, the switches SWP, SWN, SW2-SW5 are turned off during the activation period TPW2, and an output voltage YOUT_P (e.g., first voltage) is outputted via the output terminal OUT_P during the activation period TPW2 of the trigger signal TP within the line period LP(t) for implementing the overdriving operation. The output voltage YOUT_P (e.g., first voltage) may be pulled to the power supply voltage VDDA for overdriving.

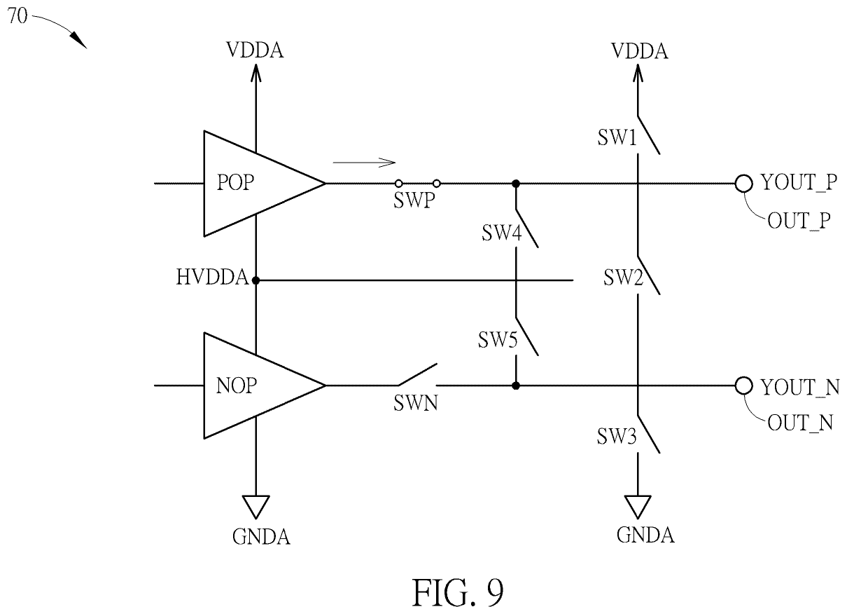

Please further refer to FIG. 6, after performing the overdriving operation in the activation period TPW2, the driving device 10 enters a normal display state and each channel driving circuit with the positive polarity may output a data driving voltage according to the corresponding channel data during the line period LP(t) to drive the display panel 20 for display purpose (normal operation). Each channel driving circuit may output the data driving voltage of channel data after the falling edge of the activation period TPW2 and before the rising edge of the activation period TPW3 to drive the display panel 20. For example, please refer to FIG. 6 and FIG. 9. FIG. 9 is a schematic diagram illustrating operations of outputting the data driving voltage corresponding to the channel data of the channel driving circuit 70 with the positive polarity according to an embodiment of the invention. As shown in FIG. 9, after the activation period TPW2, the switch SWP is turned on, the switch SWN, SW1-SW5 are turned off, and the operational amplifiers POP may generate a data driving voltage corresponding to the channel data, such that and the output voltage YOUT_P ((e.g., data driving voltage corresponding to channel data) is outputted via the output terminal OUT_P in the line period LP(t) for display.

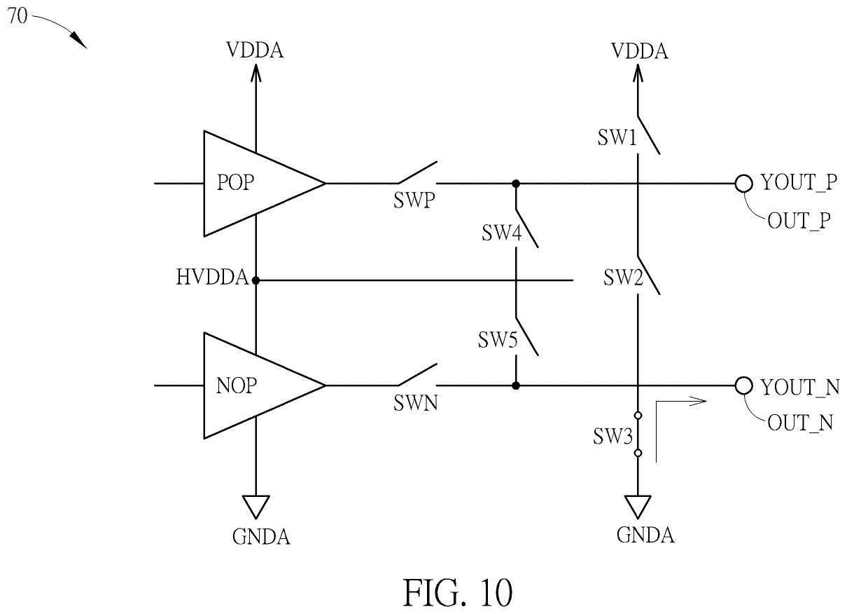

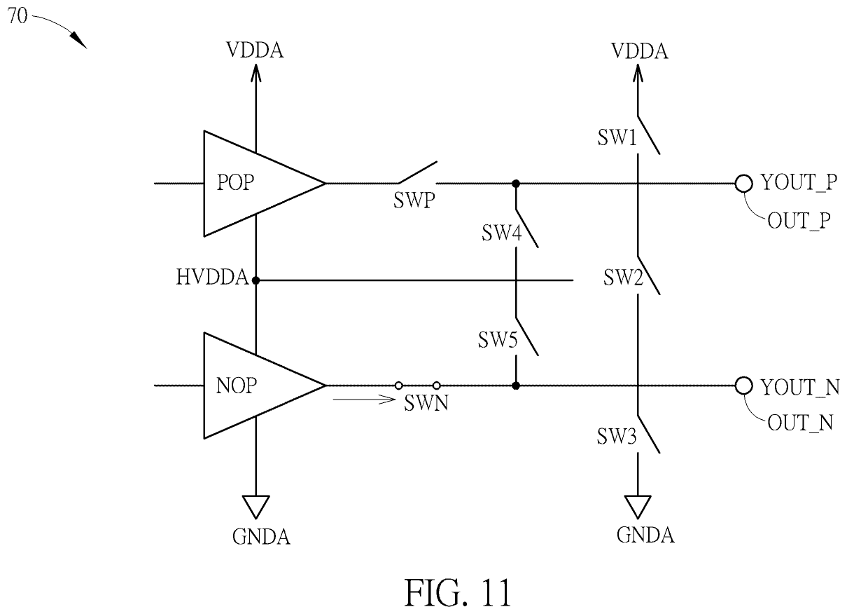

In an alternative embodiment, please refer to FIG. 6 and FIG. 10, FIG. 10 is a schematic diagram illustrating operations of the channel driving circuit 70 with the negative polarity during the activation period TPW2 of the line period LP(t) according to an embodiment of the invention. If the channel driving circuit 70 is the channel driving circuit with the negative polarity, the switch SW3 is turned on, the switches SWP, SWN, SW1-SW2 and SW4-SW5 are turned off during the activation period TPW2, and an output voltage YOUT_N (e.g., second voltage) is outputted via the output terminal OUT_N during the activation period TPW2 of the trigger signal TP within the line period LP(t) for implementing the overdriving operation. The output voltage YOUT_N (e.g., second voltage) may be pulled to the ground voltage GNDA for overdriving. After performing the overdriving operation in the activation period TPW2, the driving device 10 enters a normal display state and each channel driving circuit with the negative polarity may output a data driving voltage according to the corresponding channel data during the line period LP(t) to drive the display panel 20 for display (normal operation). For example, please refer to FIG. 11, which is a schematic diagram illustrating operations of outputting the data driving voltage corresponding to the channel data of the channel driving circuit 70 with the negative polarity according to an embodiment of the invention. As shown in FIG. 11, after the activation period TPW2, the switch SWN is turned on, the switches SWP, SW1-SW5 are turned off, and the operational amplifiers NOP may generate a data driving voltage corresponding to the channel data, such that and the output voltage YOUT_N (e.g., data driving voltage corresponding to channel data) is outputted via the output terminal OUT_N in the line period LP(t) for display.

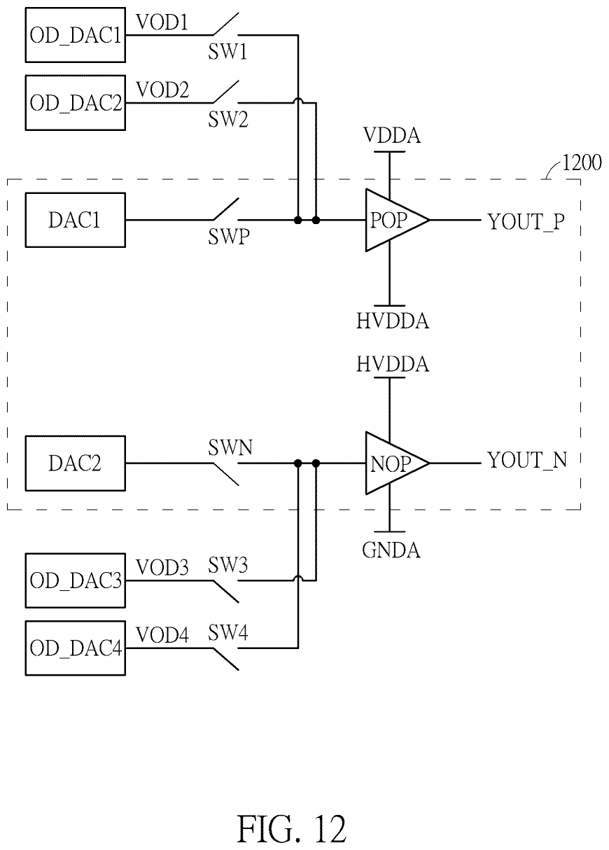

Please refer FIG. 12. FIG. 12 is a schematic diagram illustrating a channel driving circuit 1200 according to an alternative embodiment of the invention. Each of the channel driving circuits 10_1-10_n may be implemented by using the channel driving circuit 1200 of FIG. 12. As shown in FIG. 12, the driving device 10 further includes overdriving digital-to-analog converters OD_DAC1-OD_DAC4 and switches SW1-SW4. The overdriving digital-to-analog converter OD_DAC1 is configured to provide an overdriving voltage VOD1, where the overdriving voltage VOD1 may be equal to or approach the power supply voltage VDDA. The overdriving digital-to-analog converters OD_DAC2 and OD_DAC4 are configured to provide overdriving voltages VOD2 and VOD4, respectively, where the overdriving voltage s VOD2 and VOD4 may be equal to or approach the half power supply voltage HVDDA. The overdriving digital-to-analog converter OD_DAC3 is configured to provide an overdriving voltage VOD3, where the overdriving voltage VOD4 may be equal to or approach the ground voltage GNDA.

The channel driving circuit 1200 includes digital-to-analog converters DAC1 and DAC2, operational amplifiers POP and NOP, switches SWP and SWN. The operational amplifier POP may be operated between the power supply voltage VDDA and the half power supply voltage HVDDA. The operational amplifier NOP may be operated between the half power supply voltage HVDDA and the ground voltage GNDA. The switch SWP is coupled between the digital-to-analog converters DAC1 and the operational amplifier POP. The switch SWN is coupled between the digital-to-analog converters DAC2 and the operational amplifier NOP. Further, the switch SW1 is coupled between the overdriving digital-to-analog converter OD_DAC1 and the operational amplifier POP. The switch SW2 is coupled between the overdriving digital-to-analog converter OD_DAC2 and the operational amplifier POP. The switch SW3 is coupled between the overdriving digital-to-analog converter OD_DAC3 and the operational amplifier NOP. The switch SW4 is coupled between the overdriving digital-to-analog converter OD_DAC4 and the operational amplifier NOP.

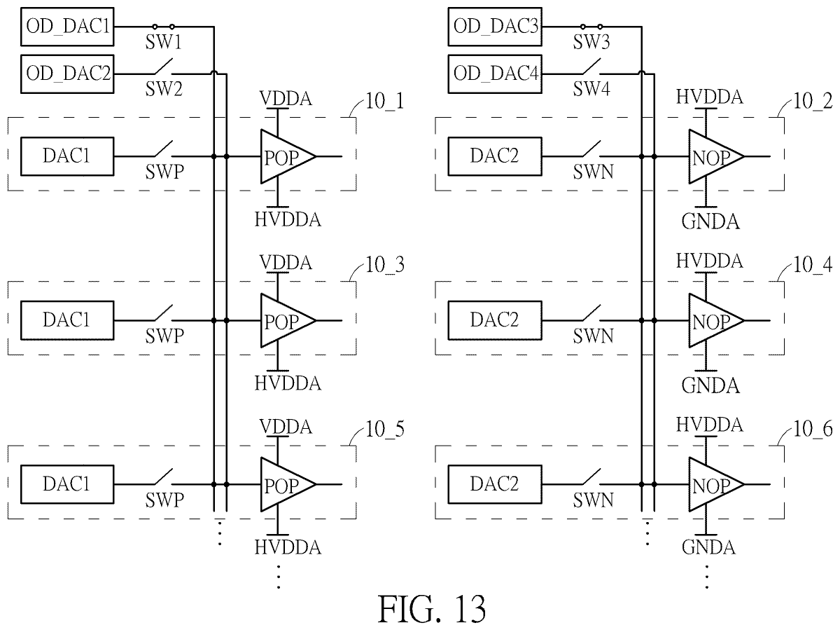

In an embodiment, please refer to FIG. 6 and FIG. 13. FIG. 13 is a schematic diagram illustrating operations of the channel driving circuits during the activation period TPW2 of the line period LP(t) according to an embodiment of the invention. Each of the channel driving circuits 10_1-10_n may be implemented by using the channel driving circuit 1200 of FIG. 12. If the odd number of channel driving circuits (e.g., channel driving circuits 10_1, 10_3, 10_5) are the channel driving circuits with the positive polarity, the even number of channel driving circuits (e.g., channel driving circuits 10_2, 10_4, 10_6) are the channel driving circuits with the negative polarity. As shown in the left side of FIG. 13, during the activation period TPW2 of the line period LP(t), the switch SW1 coupled to the channel driving circuits with the positive polarity (e.g., the odd number of channel driving circuits 10_1, 10_3, 10_5) is turned on, and the switches SW2-SW4 coupled to the odd number of channel driving circuits are turned off (not show in not show in figures). The switches SWP and SWN of the channel driving circuits with the positive polarity (e.g., the odd number of channel driving circuits 10_1, 10_3, 10_5) are also turned off (not show in not show in figures). For the channel driving circuits with the positive polarity (e.g., channel driving circuits 10_1, 10_3, 10_5), the overdriving digital-to-analog converter OD_DAC1 is configured to provide the overdriving voltage VOD1 to the operational amplifiers POP of the channel driving circuits with the positive polarity (e.g., operational amplifiers POP of the odd number of channel driving circuits 10_1, 10_3, 10_5). As such, each of the operational amplifiers POP of the channel driving circuits with the positive polarity may output an output voltage YOUT_P (e.g., first voltage) according to the overdriving voltage VOD1 during the activation period TPW2 of the trigger signal TP within the line period LP(t) for implementing the overdriving operation. The output voltage YOUT_P (e.g., first voltage) may be equal to or approach the power supply voltage VDDA.

As shown in the right side of FIG. 13, during the activation period TPW2 of the line period LP(t), the switch SW3 coupled to the channel driving circuits with the negative polarity (e.g., the even number of channel driving circuits 10_2, 10_4, 10_6) is turned on, and the switches SW1-S2, SW4 coupled to the channel driving circuits with the negative polarity are turned off (not show in not show in figures). The switches SWP and SWN of the channel driving circuits with the positive polarity (e.g., the even number of channel driving circuits 10_2, 10_4, 10_6) are also turned off (not show in not show in figures). For the channel driving circuits with the negative polarity (e.g., the even number of channel driving circuits 10_2, 10_4, 10_6), the overdriving digital-to-analog converter OD_DAC3 is configured to provide the overdriving voltage VOD3 to the operational amplifiers NOP of the channel driving circuits with the negative polarity (e.g., the even number of channel driving circuits 10_2, 10_4, 10_6). Each of the operational amplifiers NOP of the channel driving circuits with the negative polarity may output an output voltage YOUT_N (e.g., second voltage) according to the overdriving voltage VOD3 during the activation period TPW2 of the trigger signal TP within the line period LP(t) for implementing the overdriving operation. The output voltage YOUT_N (e.g., second voltage) may be equal to or approach the ground voltage GNDA.

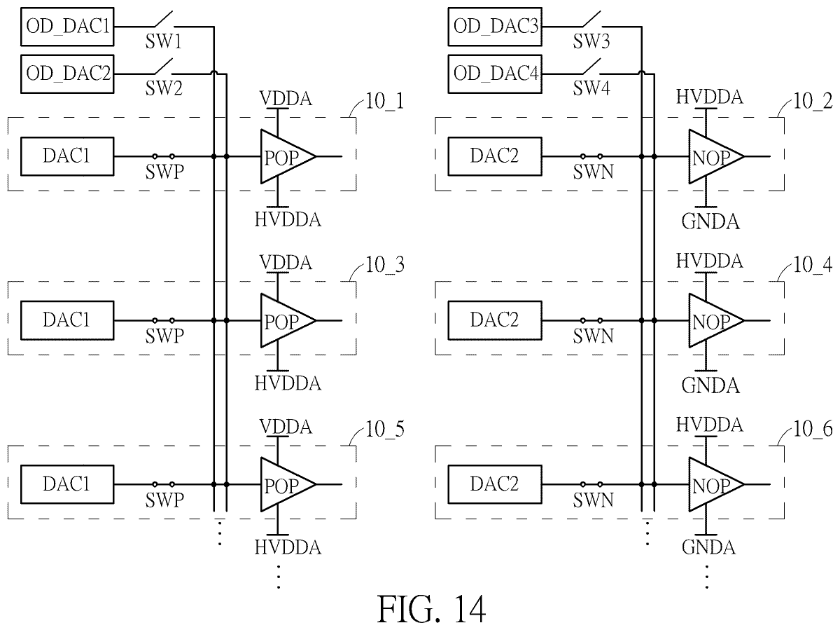

After performing the overdriving operation in the activation period TPW2, each channel driving circuit may output a data driving voltage according to the corresponding channel data during the line period LP(t) to drive the display panel 20 for display (normal operation). For example, please refer to FIG. 14, which is a schematic diagram illustrating operations of outputting the data driving voltage corresponding to the channel data of the channel driving circuits according to an embodiment of the invention. As shown in FIG. 14, after the activation period TPW2, the switches SW1-SW4 are turned off. As shown in the left side of FIG. 14, after the activation period TPW2 of the line period LP(t), the switches SWP of the channel driving circuits with the positive polarity (e.g., the odd number of channel driving circuits 10_1, 10_3, 10_5) are turned on. As shown in the right side of FIG. 14, after the activation period TPW2 of the line period LP(t), the switches SWN of the channel driving circuits with the negative polarity (e.g., the even number of channel driving circuits 10_2, 10_4, 10_6) are also turned on. Un such a situation, for each channel driving circuits with the positive polarity (e.g., the odd number of channel driving circuits 10_1, 10_3, 10_5), the digital-to-analog converters DAC1 may generate a data voltage corresponding to the channel data to the operational amplifiers POP and the operational amplifiers POP may generate an output voltage YOUT_P (e.g., data driving voltage corresponding to channel data) for display according to the data voltage generated by the digital-to-analog converters DAC1. For each channel driving circuits with the negative polarity (e.g., the even number of channel driving circuits 10_2, 10_4, 10_6), the digital-to-analog converters DAC2 may generate a data voltage corresponding to the channel data to the operational amplifiers NOP and the operational amplifiers NOP may generate an output voltage YOUT_N (e.g., data driving voltage corresponding to channel data) for display according to the data voltage generated by the digital-to-analog converters DAC2.

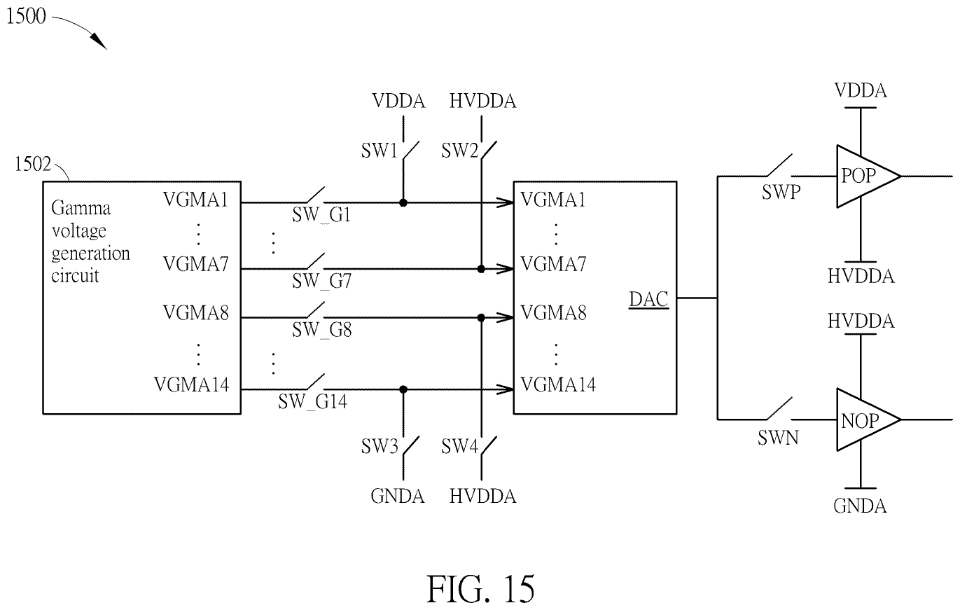

Please refer FIG. 15. FIG. 15 is a schematic diagram illustrating a channel driving circuit 1500 according to an alternative embodiment of the invention. Each of the channel driving circuits 10_1 to 10_n may be implemented by using the channel driving circuit 1500 of FIG. 15. As shown in FIG. 15, the channel driving circuit 1500 includes a gamma voltage generation circuit 1502, a digital-to-analog converter DAC, operational amplifiers POP and NOP, and switches SWP, SWN, SW1-SW4 and SW_G1-SW_G14. The gamma voltage generation circuit 1502 is configured to generate a plurality of gamma voltages (e.g., gamma voltages VGMA1 to VGMA14) to the digital-to-analog converter DAC. The operational amplifier POP may be operated between the power supply voltage VDDA and the half power supply voltage HVDDA and capable of outputting a data driving voltage of positive polarity. The operational amplifier NOP may be operated between the half power supply voltage HVDDA and the ground voltage GNDA and capable of outputting a data driving voltage of negative polarity. The switch SW1 is coupled between a power supply terminal of the power supply voltage VDDA and the digital-to-analog converter DAC. The switch SW2 is coupled between a power supply terminal of the half power supply voltage HVDDA and the digital-to-analog converter DAC. The switch SW3 is coupled between a ground terminal of the ground voltage VDDA and the digital-to-analog converter DAC. The switch SW2 is coupled between a power supply terminal of the half power supply voltage HVDDA and the digital-to-analog converter DAC. The switch SWP is coupled between the digital-to-analog converter DAC and the operational amplifier POP. The switch SWN is coupled between the digital-to-analog converter DAC and the operational amplifier NOP.

As shown in FIG. 15, for the channel driving circuit with the positive polarity, the switches SW1 and SWP are turned on and the digital-to-analog converter DAC outputs the power supply voltage VDDA to the operational amplifiers POP, such that the operational amplifier POP with the positive polarity may output an output voltage YOUT_P (e.g., first voltage) during the activation period TPW2 of the trigger signal TP within the line period LP(t) for implementing the overdriving operation. The output voltage YOUT_P (e.g., first voltage) may be equal to or approach the power supply voltage VDDA. For the channel driving circuit with the negative polarity, the switch SW3 and SWN are turned on and the digital-to-analog converter DAC output the ground voltage GNDA to the operational amplifiers NOP, such that the operational amplifier NOP with the negative polarity may output an output voltage YOUT_N (e.g., second voltage) during the activation period TPW2 of the trigger signal TP within the line period LP(t) for implementing the overdriving operation. The output voltage YOUT_N (e.g., second voltage) may be equal to or approach the ground voltage GNDA.

In Step S208, in response to determining that the channel driving circuits performs the charge sharing operation for the line period, the channel driving circuits 10_1-10_n perform a charge sharing operation for temperature reducing according to a trigger signal during the line period. For example, please further refer to FIG. 6, the channel driving circuits 10_1-10_n may perform the charge sharing operation during an activation period TPW3 of the trigger signal TP within the line period within the line period LP(t+1) since the processing circuit 100 determines to perform the charge sharing operation for the line period LP(t+1) in Step S204. For example, please refer further to FIG. 7, the switch SW2 is turned on, the switches SWP, SWN, SW1, SW3-SW5 are turned off during the activation period TPW3, and a charge sharing operation is performed for temperature reducing during the activation period TPW3 of the trigger signal TP within the line period LP(t).

After performing the charge sharing operation in the activation period TPW3, the driving device 10 enters a normal display state and each channel driving circuit with the positive polarity may output a data driving voltage according to the corresponding channel data during the line period LP(t+1) to drive the display panel 20 for display purpose (normal operation). Each channel driving circuit may output the data driving voltage of channel data after the falling edge of the activation period TPW3 and before the rising edge of the activation period TPW4 to drive the display panel 20. After the activation period TPW3, the switch SWP of the channel driving circuit with the positive polarity is turned on, and other switches are turned off, and the operational amplifier POP may generate a data driving voltage corresponding to the channel data for display. After the activation period TPW3, the switch SWN of the channel driving circuit with the negative polarity is turned on, and other switches are turned off, and the operational amplifier NOP may generate a data driving voltage corresponding to the channel data for display.

In Step S208, in response to determining that the channel driving circuits performs the overdriving operation to the half power supply voltage HVDDA for the line period, the channel driving circuits 10_1-10_n perform the overdriving operation to the half power supply voltage HVDDA for temperature reducing according to a trigger signal during the line period. For example, please further refer to FIG. 6, the channel driving circuits 10_1-10_n may perform the overdriving operation to the half power supply voltage HVDDA during an activation period TPW3 of the trigger signal TP within the line period within the line period LP(t+1) since the processing circuit 100 determines to perform the overdriving operation to the half power supply voltage HVDDA for the line period LP(t+1) in Step S204. For example, please further refer to FIG. 7, as shown in FIG. 7, the switch SW4 and SW5 are turned on, the switches SWP, SWN, SW1-SW3 are turned off during the activation period TPW3, and the output voltage YOUT_P or YOUT_N (e.g., third voltage) is pulled to the half power supply voltage HVDDA for overdriving. After performing the overdriving operation in the activation period TPW3, the driving device 10 enters a normal display state and each channel driving circuit may output a data driving voltage according to the corresponding channel data during the falling edge of the activation period TPW3 and the rising edge of the activation period TPW4 of the line period LP(t+1) to drive the display panel 20 for display purpose (normal operation).

For example, please further refer to FIG. 12, as shown in FIG. 12, during the activation period TPW3 of the line period LP(t+1), the switches SW2 and SW3 are turned on, and the switches SWP and SWN of the channel driving circuits are also turned off. The overdriving digital-to-analog converters OD_DAC2 and OD_DAC3 is configured to provide the overdriving voltages VOD2 and VOD3 to the operational amplifiers POP and NOP of the channel driving circuits. As such, each of the operational amplifiers POP and NOP of the channel driving circuits may output an output voltage (e.g., third voltage) according to the overdriving voltages VOD2 and VOD3 during the activation period TPW3 of the trigger signal TP within the line period LP(t+1) for implementing the overdriving operation. The output voltage (e.g., third voltage) may be equal to or approach the half power supply voltage HVDDA. For example, please further refer to FIG. 15, as shown in FIG. 15, during the activation period TPW3 of the line period LP(t+1), the switches SW2, SW4, SWP, SWN are turned on and the digital-to-analog converter DAC outputs the half power supply voltage HVDDA to the operational amplifiers POP and NOP, such that the operational amplifier POP and NOP may output an output voltage (e.g., third voltage) for implementing the overdriving operation during the activation period TPW3 of the trigger signal TP within the line period LP(t+1) for implementing the overdriving operation. The output voltage (e.g., third voltage) may be equal to or approach the half power supply voltage HVDDA.

In summary, the embodiments of the invention provide the temperature reducing operation by using the overdriving operation and charge sharing operation and thus, the power consumption may be reduced and the operating temperature may be decreased without addition heat dissipation module.

Those skilled in the art will readily observe that numerous modifications and alterations of the device and method may be made while retaining the teachings of the invention. Accordingly, the above disclosure should be construed as limited only by the metes and bounds of the appended claims.

1. A control method for reducing operating temperature of a driving device, the driving device comprising a plurality of channel driving circuits, the control method comprising:
enabling an over-temperature sensing function to determine whether to perform a temperature reducing operation;
detecting whether display frame data to be displayed includes a heavy load pattern;
determining to perform the temperature reducing operation in response to determining that the display frame data to be displayed includes the heavy load pattern; and
for each line period, determining that the plurality of channel driving circuits perform a charge sharing operation for temperature reducing during an activation period of a trigger signal within the line period based on determining that a gray level of channel data of a channel in the line period is smaller than a gray level of channel data of the channel in a previous line period before the line period in response to determining to perform the temperature reducing operation.

2. (canceled)

3. The control method of claim 1, further comprising:
determining that the plurality of channel driving circuits perform an overdriving operation to a power supply voltage or a ground voltage for temperature reducing during the activation period of the trigger signal within the line period based on determining that the gray level of channel data of the channel in the line period is greater than the gray level of channel data of the channel in the previous line period.

4. The control method of claim 3, further comprising:
outputting, by a channel driving circuit with a positive polarity of the driving device, a first voltage during the activation period of the trigger signal within the line period for implementing the overdriving operation, wherein the first voltage is the power supply voltage; and
outputting, by a channel driving circuit with a negative polarity of the driving device, a second voltage during the activation period of the trigger signal within the line period for implementing the overdriving operation, wherein the second voltage is the ground voltage.

5. (canceled)

6. A control method for reducing operating temperature of a driving device, the driving device comprising a plurality of channel driving circuits, the control method comprising:
enabling an over-temperature sensing function to determine whether to perform a temperature reducing operation;
detecting whether display frame data to be displayed includes a heavy load pattern;
determining to perform the temperature reducing operation in response to determining that the display frame data to be displayed includes the heavy load pattern; and
for each line period, determining that the plurality of channel driving circuits perform an overdriving operation to a half power supply voltage for temperature reducing during an activation period of a trigger signal within the line period based on determining that a gray level of channel data of a channel in the line period is smaller than a gray level of channel data of the channel in a previous line period in response to determining to perform the temperature reducing operation.

7. The control method of claim 1, further comprising:
determining that the plurality of channel driving circuits perform an overdriving operation to a power supply voltage or a ground voltage during the activation period of the trigger signal within the line period based on determining that the gray level of channel data of the channel in the line period is greater than the gray level of channel data of the channel in the previous line period, and an absolute difference of the gray level of channel data of the channel in the line period and the gray level of channel data of the channel in the previous line period is greater than a first threshold.

8. The control method of claim 1, further comprising:
determining that the plurality of channel driving circuits perform the charge sharing operation or an overdriving operation to a half power supply voltage during the activation period of the trigger signal within the line period based on determining that the gray level of channel data of the channel in the line period is smaller than the gray level of channel data of the channel in the previous line period, and an absolute difference of the gray level of channel data of the channel in the line period and the gray level of channel data of the channel in the previous line period is greater than a second threshold.

9. A driving device comprising:
a plurality of channel driving circuits; and
a processing circuit, configured to enable an over-temperature sensing function and determine whether to perform a temperature reducing operation; wherein the processing circuit is configured to detect whether display frame data to be displayed includes a heavy load pattern and determine to perform the temperature reducing operation in response to determining that the display frame data to be displayed includes the heavy load pattern;
wherein for each line period, the processing circuit is further configured to determine that the plurality of channel driving circuits perform a charge sharing operation for temperature reducing during an activation period of a trigger signal within the line period based on determining that a gray level of channel data of a channel in the line period is smaller than a gray level of channel data of the channel in a previous line period before the line period in response to determining to perform the temperature reducing operation.

10. (canceled)

11. The driving device of claim 9, wherein the processing circuit is configured to determine that the plurality of channel driving circuits perform an overdriving operation to a power supply voltage or a ground voltage during the activation period of the trigger signal within the line period based on determining that the gray level of channel data of the channel in the line period is greater than the gray level of channel data of the channel in the previous line period.

12. The driving device of claim 11, wherein the channel driving circuit is configured to output a first voltage during the activation period of the trigger signal within the line period for implementing the overdriving operation when the channel driving circuit is a channel driving circuit with a positive polarity, wherein the first voltage is the power supply voltage, and the channel driving circuit is configured to output a second voltage during the activation period of the trigger signal within the line period for implementing the overdriving operation when the channel driving circuit is a channel driving circuit with a negative polarity, wherein the second voltage is the ground voltage.

13. The driving device of claim 12, wherein each channel driving circuit comprises:
a first operational amplifier, operating between the power supply voltage and a half power supply voltage;
a second operational amplifier, operating between the half power supply voltage and the ground voltage;
a first switch, coupled between the first operational amplifier and a first output terminal;
a second switch, comprising a first terminal coupled to the power supply voltage, and a second terminal coupled to the first output terminal;
a third switch, coupled between the second operational amplifier and a second output terminal; and
a fourth switch, comprising a first terminal coupled to the ground voltage, and a second terminal coupled to the second output terminal;
wherein when the channel driving circuit is a channel driving circuit with a positive polarity, the second switch is turned on, the first switch, the third switch and the fourth switch are turned off, and the first voltage is outputted via the first output terminal during the activation period of the trigger signal within the line period for implementing the overdriving operation.

14. The driving device of claim 13, wherein when the channel driving circuit is the channel driving circuit with the negative polarity, the fourth switch is turned on, the first switch, the second switch and the third switch are turned off, and the second voltage is outputted via the second output terminal during the activation period of the trigger signal within the line period for implementing the overdriving operation.

15. The driving device of claim 12, further comprising:
a first overdriving digital-to-analog converter, configured to output a first overdriving voltage equal to the power supply voltage; and
a second overdriving digital-to-analog converter, configured to output a second overdriving voltage equal to the ground voltage;
wherein each channel driving circuit comprises:
a first digital-to-analog converter;
a second digital-to-analog converter;
a third operational amplifier, operating between the power supply voltage and a half power supply voltage;
a fourth operational amplifier, operating between the half power supply voltage and the ground voltage;
a fifth switch, coupled between the first digital-to-analog converter and the third operational amplifier;
a sixth switch, coupled between the first overdriving digital-to-analog converter and the third operational amplifier;
a seventh switch, coupled between the second digital-to-analog converter and the fourth operational amplifier; and
an eighth switch, coupled between the second overdriving digital-to-analog converter and the fourth operational amplifier;
wherein when the channel driving circuit is the channel driving circuit with the positive polarity, the sixth switch is turned on, the fifth switch, the seventh switch and the eighth switch are turned off, and the first overdriving digital-to-analog converter is configured to output the first overdriving voltage equal to the power supply voltage to drive the third operational amplifier such that the first voltage is outputted during the activation period of the trigger signal within the line period for implementing the overdriving operation.

16. The driving device of claim 15, wherein when the channel driving circuit is the channel driving circuit with the negative polarity, the eighth switch is turned on, the fifth switch, the sixth switch and the seventh switch are turned off, and the second overdriving digital-to-analog converter is configured to output the voltage equal to the ground voltage to drive the fourth operational amplifier such that the second voltage is outputted during the activation period of the trigger signal within the line period for implementing the overdriving operation.

17. The driving device of claim 12, wherein each channel driving circuit comprises:
a gamma voltage generation circuit, configured to generate a plurality of gamma voltages;
a digital-to-analog converter, coupled to the gamma voltage generation circuit;
a fifth operational amplifier, operating between the power supply voltage and a half power supply voltage;
a sixth operational amplifier, operating between the half power supply voltage and the ground voltage;
a ninth switch, coupled between a power supply terminal of the power supply voltage and the digital-to-analog converter;
a tenth switch, coupled between the digital-to-analog converter and the fifth operational amplifier;
an eleventh switch, coupled between a ground terminal of the ground voltage and the digital-to-analog converter; and
a twelfth switch, coupled between the digital-to-analog converter and the sixth operational amplifier;
wherein when the channel driving circuit is a channel driving circuit with a positive polarity, the ninth switch and the tenth switch are turned on, the eleventh switch and the twelfth switch are turned off, and the first voltage is outputted by the fifth operational amplifier during the activation period of the trigger signal within the line period for implementing the overdriving operation.

18. The driving device of claim 17, wherein when the channel driving circuit is the channel driving circuit with the negative polarity, the eleventh switch and the twelfth switch are turned on, the ninth switch and the tenth switch are turned off, and the second voltage is outputted by the sixth operational amplifier during the activation period of the trigger signal within the line period for implementing the overdriving operation.

19. (canceled)

20. A driving device comprising:
a plurality of channel driving circuits; and
a processing circuit, configured to enable an over-temperature sensing function and determine whether to perform a temperature reducing operation; wherein the processing circuit is configured to detect whether display frame data to be displayed includes a heavy load pattern and determine to perform the temperature reducing operation in response to determining that the display frame data to be displayed includes the heavy load pattern;
wherein for each line period, the processing circuit is configured to determine that the plurality of channel driving circuits perform an overdriving operation to a half power supply voltage for temperature reducing during an activation period of a trigger signal within the line period based on determining that a gray level of channel data of a channel in the line period is smaller than a gray level of channel data of the channel in a previous line period in response to determining to perform the temperature reducing operation.

21. The driving device of claim 9, wherein the processing circuit is configured to determine that the plurality of channel driving circuits perform an overdriving operation to a power supply voltage or a ground voltage during the activation period of the trigger signal within the line period based on determining that the gray level of channel data of the channel in the line period is greater than the gray level of channel data of the channel in the previous line period, and an absolute difference of the gray level of channel data of the channel in the line period and the gray level of channel data of the channel in the previous line period is greater than a first threshold.

22. The driving device of claim 9, wherein the processing circuit is configured to determine that the plurality of channel driving circuits perform the charge sharing operation or an overdriving operation to a half power supply voltage during the activation period of the trigger signal within the line period based on determining that the gray level of channel data of the channel in the line period is smaller than the gray level of channel data of the channel in the previous line period, and an absolute difference of the gray level of channel data of the channel in the line period and the gray level of channel data of the channel in the previous line period is greater than a second threshold.
